(19) United States
(12) Patent Application Publication
(10) Pub. No.: US 2023/0010888 A1
(43) Pub. Date: Jan. 12, 2023

(54) Vacuum Smelting of Sorted Aluminum

(71) Applicant: Sortera Alloys, Inc., Fort Worth, TX (US)

(72) Inventor: Nalin Kumar, Fort Worth, TX (US)

(73) Assignee: Sortera Alloys, Inc., Fort Worth, TX (US)

(21) Appl. No.: 17/852,969

(22) Filed: Jun. 29, 2022

Related U.S. Application Data
(60) Provisional application No. 63/219,136, filed on Jul. 7, 2021.

(51) Int. Cl. C22C 21/00; C22C 1/02; C22B 21/00

(52) U.S. Cl. CPC C22C 21/00; C22C 1/026; C22B 21/0092

(57) ABSTRACT

Aluminum scrap pieces are sorted into selected alloys and then fed into a vacuum smelting furnace to melt. The aluminum scrap pieces may be sorted into various cast aluminum alloy series, wrought aluminum alloy series, or extrusion aluminum alloy series. The sorting may be performed using x-ray fluorescence, artificial intelligence, or laser induced breakdown spectroscopy.

This application claims priority to U.S. Provisional Patent Application Ser. No. 63/219,136, which is hereby incorporated by reference herein.

### GOVERNMENT LICENSE RIGHTS

This disclosure was made with U.S. government support under Grant No. DE-AR0001238 awarded by the U.S. Department of Energy. The U.S. government may have certain rights in this disclosure.

### TECHNICAL FIELD

This invention relates to recycling of aluminum, and more particularly to the sorting and smelting of aluminum alloys.

### BACKGROUND

Currently, aluminum production is one of the most energy-intensive industrial processes worldwide using approximately 2-3% of the global electricity and contributing approximately 1% of global carbon dioxide (CO₂) emissions. Over the next 30 years, aluminum demand is expected to grow 2-3 times from the recent production levels of ˜50 million tons. Thus, it is important to develop alternative technologies to current aluminum production methods.

Almost all of the primary aluminum production uses a century old Bayer process of converting bauxite ore into alumina and the Hall-Heroult process (patented in 1886) involving electrolytic reduction of alumina into aluminum, which requires about 13,000 kWh/ton (47 GJ/ton) in state-of-the-art manufacturing, making it the most energy intensive step in the aluminum production. The CO₂ emissions are caused by two means: (i) indirect emissions from fossil fuel powered generation of electricity (e.g., only about one third of the required electricity is produced by hydro-electric plants), and (ii) direct emissions from the carbon anodes used in the electrolysis cells (e.g., as much as about 1.6 kg of CO₂ is emitted for every kg of aluminum produced).

Over the last several decades, there has been extensive research to replace the carbon anode with various types of “inert” anodes, but these efforts have met with varying success. However, none of these processes have gone into mass production yet, and essentially all commercial operations still produce primary aluminum by a combination of the Bayer and Hall-Heroult processes. Attempts to develop alternative carbothermic smelting processes (use of high temperature carbon-based reduction of alumina) go as far back as before the development of the Hall-Heroult process. However, these processes suffer from various problems such as high temperature and energy requirements. Nevertheless, the fact remains that, thermodynamically, carbothermic smelting processes will generate significantly more CO₂ than the current processes, and thus are highly undesirable.

Due to these difficulties to develop an alternative to the current aluminum production process, there has been increasing emphasis on developing technologies to recycle aluminum at lower CO₂ emissions and energy consumption; thereby indirectly reducing the need for producing primary aluminum from bauxite ore. Currently, almost 60% of aluminum used in the United States is from secondary aluminum smelters. Aluminum recycling is thermodynamically 20 times more efficient than the current primary aluminum production, but the current processes are very rudimentary.

To more fully understand the issues, it is important to understand the current secondary aluminum production method. Currently, scrap aluminum is generated from shredding of end-of-life automobiles, appliances, and construction/demolition (e.g., siding) scrap. Scrap aluminum (often referred to as “Twitch”) is separated from other heavier metals (e.g., copper, zinc, brass, and stainless steel) using a “sink-float” method or eddy current sorters. Twitch may contain various types of aluminum alloys including (i) cast aluminum alloys (e.g., 319, 356, 380, and 383 series aluminum alloys; all containing 6-15% silicon) used for automotive engine blocks, transmissions, and alloy wheels, (ii) wrought aluminum alloys (different series aluminum alloys such as 2xxx series aluminum alloys containing copper, 3xxx series aluminum alloys containing manganese, 5xxx series aluminum alloys containing magnesium, 6xxx series aluminum alloys containing 1% silicon, and 7xxx series aluminum alloys containing zinc) used for sheet metal hoods and doors, aircraft frames, and aluminum siding, and (iii) aluminum extrusions (6xxx series aluminum alloys) used for automotive frames and general purpose aluminum frames. Currently, all these aluminum alloys are collected and melted together in large induction, rotary, and vibratory furnaces to manufacture aluminum ingots (typically, 3,000 pounds each) resulting in an aluminum mixture containing small amounts of all of the above elements. Due to the mixture of scrap aluminum containing magnesium, silicon, zinc, copper, and iron, the only product that can be feasibly produced is the lowest grade aluminum used for engine blocks, namely A380 series cast aluminum containing 8-12% silicon. Moreover, there are several issues in the current A380 aluminum production.

During the aluminum melting process, the aluminum surface is constantly exposed to atmospheric air, and the surface turns back into aluminum oxide, resulting in a melt loss as high as 5%, leading to a direct lost value as well as an indirect cost increase in removing the oxidized aluminum as “slag” from the furnace/final ingot.

The price/value of the cast A380 is the lowest of all the aluminum alloys (for example, as compared to wrought aluminum alloys, which command 10-25% higher prices). However, higher value sheet metal wrought aluminum alloys cannot contain more than 1% silicon, and thus cannot be produced from the above-noted mixture. Hence, almost all wrought aluminum alloys are produced from primary aluminum (except for close-circuit aluminum recycling, such as from beverage cans and Ford F-150 sheet metal spiders).

The final A380 ingot cannot contain more than 0.1% magnesium (as per A380 specifications) because the inclusion of Mg degrades the hardness properties of cast aluminum alloys. Thus, aluminum smelters use chlorine to remove magnesium from the aluminum alloy melt by bubbling chlorine gas through the melt, which turns Mg into MgCl₂, a solid that floats to the melt surface and is removed from the furnace. Chlorine gas is very toxic, expensive to handle, and a detriment to the environment.

It has been estimated that the aluminum melting during the smelting process costs about $0.10 per pound, adding almost 10-12% to the price of the A380 ingot. Once this ingot reaches the end customer, it has to be melted again to manufacture the end-use products such as engine blocks or other castings. This doubles the energy requirement. In fact, in certain industrial areas where the aluminum foundries and the smelters are located in close vicinity, molten aluminum is shipped in special trucks from the smelter to the foundry to avoid this second melting step.

### BRIEF DESCRIPTION OF DRAWINGS

FIG. 1 illustrates a schematic block diagram configured in accordance with the present disclosure.

FIG. 2 illustrates a schematic diagram of an apparatus for vacuum smelting.

### DETAILED DESCRIPTION

Embodiments of the present disclosure provide an innovative aluminum smelting technology that significantly increases the range of aluminum alloys that can be manufactured from recycling of scrap aluminum, resulting in a reduction of need for primary aluminum with corresponding 95% energy and CO₂ emission reduction benefits. Embodiments of the present disclosure melt pre-sorted aluminum alloys (e.g., using a sorter such as disclosed in U.S. Pat. Nos. 10,207,296, 10,710,119, and/or 10,722,922, all of which are hereby incorporated by reference herein) in an energy efficient vacuum smelting furnace, which avoids the typical 5% metal loss due to oxidation of molten metal. In addition, pre-sorting scrap into different categories (e.g., cast, wrought, extrusion, and/or aerospace) enables for a lower cost production of high value aluminum alloys without the need for adding alloying elements to primary aluminum. For example, certain embodiments of the present disclosure are configured to remove magnesium containing aluminum alloy (e.g., 5xxx aluminum alloys) pieces before adding the resultant raw scrap to the vacuum smelting furnace (for example, see U.S. Pat. No. 10,722,922). Thus, the current practice of using chlorine to remove magnesium in the molten mixed scrap is no longer necessary when pre-sorted cast alloys are used to manufacture A380 ingots.

In accordance with certain embodiments of the present disclosure, a vacuum smelting furnace as disclosed herein can be used as a point-of-use smelter at various foundries creating a disruptive paradigm in the aluminum recycling (currently ˜60% of total aluminum usage in the U.S.), where the end user can purchase a load of aluminum scrap pre-sorted to produce a particular alloy when melted instead of A380 ingots, thereby avoiding an extra melting step between scrap aluminum and final product. This can result in almost 50% energy savings during melting of recycled aluminum to make products. Embodiments of the present disclosure may also be utilized to improve the energy efficiency of primary aluminum production as investigated recently by the Paul Scherrer Institute (see E. Balomenos et al., “Carbothermic Reduction of Alumina: A Review of Developed Processes and Novel Concepts,” Proceedings of European Metallurgical Conference (EMC-2011), vol. 3, pp. 729-744, which is hereby incorporated by reference herein).

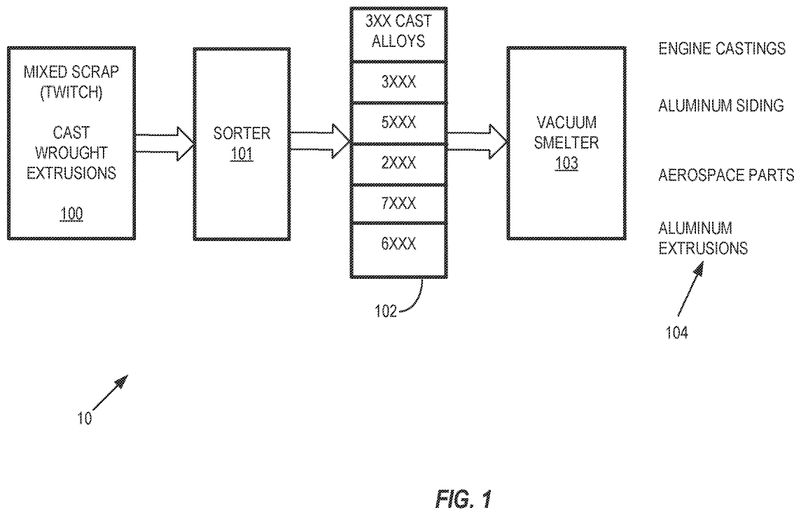

FIG. 1 illustrates a schematic block diagram of a system and method 10 configured in accordance with embodiments of the present disclosure for increasing the efficiency and cost effectiveness of secondary aluminum production. Mixed aluminum scrap (e.g., Twitch) 100 may be sorted into one or more desired groupings (classifications) of cast aluminum, wrought aluminum, and/or extrusion aluminum alloys 102 (e.g., by cast, wrought, or extrusion series) utilizing an XRF/artificial intelligence technology sorter 101, such as disclosed in any one or more of U.S. Pat. Nos. 10,207,296, 10,710,119, and/or 10,722,922. An artificial intelligence technology sorter may sort the scrap pieces based on captured visual images of the pieces. In accordance with certain embodiments of the present disclosure, a LIBS device or some other appropriate sensor may be utilized for classifying and sorting certain types of aluminum alloys. For example, see the system 100 illustrated and described in U.S. Pat. No. 10,710,119.

Then, a vacuum smelting furnace 103 is utilized to avoid oxidation of the molten aluminum made from the sorted scrap. In other words, one of the sorted cast aluminum, wrought aluminum, and/or extrusion aluminum alloy pieces are inserted into the vacuum smelting furnace 103. The resultant molten aluminum may then be made into an appropriate product 104 (e.g., engine castings, aluminum siding, aerospace parts, aluminum extrusions, etc.).

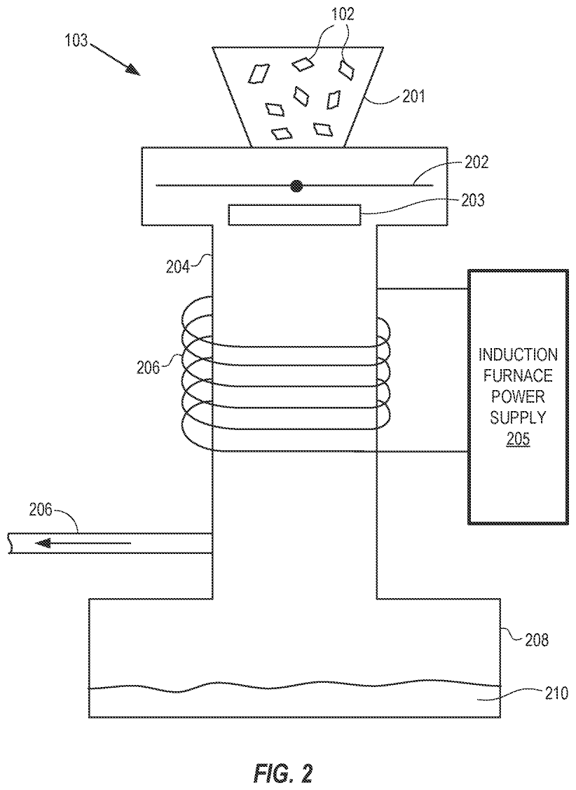

Referring next to FIG. 2, there is illustrated a simplified schematic diagram of a vacuum smelting furnace 103 configured in accordance with embodiments of the present disclosure. Some sort of feeding mechanism or hopper 201 may be attached to the top of the furnace 103 in order to feed the sorted aluminum scrap pieces 102 into the furnace 103. A baffle 203 may be inserted above the column 204 of the furnace 103 in order to ensure that the scrap pieces 102 fall more slowly and less in groups through the column 204. After a certain number of sorted aluminum pieces 102 have been fed into the furnace 103, a load lock vacuum valve 202 may be utilized to ensure that the furnace 103 achieves an appropriate vacuum created by a vacuum pump (not shown) coupled to the furnace 103 by a vacuum tube 207. The furnace column 204 is wrapped with a water-cooled coil 206 that is powered by an induction furnace power supply 205. As the aluminum scrap pieces 102 melt, they are captured in the bottom of the furnace 208, and the molten aluminum 210 may then be drained off. In accordance with embodiments of the present disclosure, a vacuum smelting furnace manufactured by T-M Vacuum Products, Inc. of New Jersey may be utilized, which is capable of achieving 1400 degrees Celsius in a vacuum (e.g., pumped with a combination of mechanical and turbo pumps).

The use of vacuum has the following advantages:

(i) No oxidation of molten aluminum thereby avoiding melt loss to slag formation (typically 5% of metal is lost in this process). Aluminum does not dissolve gases when it melts in a vacuum; metals rarely oxidize when they are heated to higher temperatures in a vacuum, whether they are solid or liquid; gases follow the ideal gas equation.

(ii) A high vacuum is not required; thus, a vacuum level of even about 0.1 atmosphere can significantly reduce oxidation. As a result, low-cost blowers can be used to create the necessary vacuum, and lower cost vacuum chambers can be used.

(iii) Various types of heating sources such as induction heating, electric arc sources, and electric filament heaters can be used depending on the size of the furnace. Electric arc furnaces larger than 100 KW are commercially available and are commonly used. In addition, vacuum furnaces that are gas heated are also available where cheap natural gas is available.

The vacuum smelting technology of the present disclosure lends itself to be used for production of A380 alloy ingots from pre-sorted cast alloy scrap (substantially free from aluminum alloy pieces containing magnesium (less than 0.1% wt. magnesium)) without using chlorine gas to metallurgically remove magnesium from the molten alloy aluminum, resulting in cost and environmental benefits.

The vacuum smelting technology may also be utilized for developing an integrated sorter-smelter machine 10 for small foundries as a point-of-use for implementing a direct scrap-to-castings manufacturing process. This removes the extra step of aluminum melting to fabricate ingots resulting in 50% energy savings (i.e., one melting step instead of two steps).

In the descriptions herein, numerous specific details are provided, such as examples of programming, software modules, user selections, network transactions, database queries, database structures, hardware modules, hardware circuits, hardware chips, controllers, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations may be not shown or described in detail to avoid obscuring aspects of the disclosure.

Reference throughout this specification to “an embodiment,” “embodiments,” or similar language means that a particular feature, structure, or characteristic described in connection with the embodiments is included in at least one embodiment of the present disclosure. Thus, appearances of the phrases “in one embodiment,” “in an embodiment,” “embodiments,” “certain embodiments,” “various embodiments,” and similar language throughout this specification may, but do not necessarily, all refer to the same embodiment. Furthermore, the described features, structures, aspects, and/or characteristics of the disclosure may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

Benefits, advantages, and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims. Further, no component described herein is required for the practice of the disclosure unless expressly described as essential or critical.

Those skilled in the art having read this disclosure will recognize that changes and modifications may be made to the embodiments without departing from the scope of the present disclosure. It should be appreciated that the particular implementations shown and described herein may be illustrative of the disclosure and its best mode and may be not intended to otherwise limit the scope of the present disclosure in any way. Other variations may be within the scope of the following claims.

While this specification contains many specifics, these should not be construed as limitations on the scope of the disclosure or of what can be claimed, but rather as descriptions of features specific to particular implementations of the disclosure. Headings herein may be not intended to limit the disclosure, embodiments of the disclosure or other matter disclosed under the headings.

Herein, the term “or” may be intended to be inclusive, wherein “A or B” includes A or B and also includes both A and B. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The terminology used herein is for the purpose of describing particular embodiments only and is not intended to be limiting of the disclosure. As used herein, the singular forms “a,” “an,” and “the” may be intended to include the plural forms as well, unless the context clearly indicates otherwise.

The corresponding structures, materials, acts, and equivalents of all means or step plus function elements in the claims below may be intended to include any structure, material, or act for performing the function in combination with other claimed elements as specifically claimed.

As used herein with respect to an identified property or circumstance, “substantially” refers to a degree of deviation that is sufficiently small so as to not measurably detract from the identified property or circumstance. The exact degree of deviation allowable may in some cases depend on the specific context.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a defacto equivalent of any other member of the same list solely based on their presentation in a common group without indications to the contrary.

Unless defined otherwise, all technical and scientific terms (such as acronyms used for chemical elements within the periodic table) used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that can vary depending upon the desired properties sought to be obtained by the presently disclosed subject matter. As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

What is claimed is:

1. A system comprising:
a sorter configured to sort a mixture of different aluminum alloy scrap pieces to produce at least one collection of aluminum alloy scrap pieces substantially composed of a single aluminum alloy; and
a vacuum smelting furnace configured to melt the collection of aluminum alloy scrap pieces.

2. The system as recited in claim 1, wherein the different aluminum alloy scrap pieces are selected from a group consisting of cast aluminum alloy scrap pieces, wrought aluminum alloy scrap pieces, and extrusion aluminum alloy scrap pieces.

3. The system as recited in claim 1, wherein the sorter is configured to sort the mixture of different aluminum alloy scrap pieces with an artificial intelligence neural network.

4. The system as recited in claim 3, wherein the artificial intelligence neural network is configured to sort the scrap pieces based on captured visual images of the pieces.

5. The system as recited in claim 1, wherein the collection of aluminum alloy scrap pieces contains less than 0.1% wt. magnesium.

6. A method comprising:
sorting a mixture of different aluminum alloy scrap pieces to produce a collection of aluminum alloy scrap pieces substantially composed of a single aluminum alloy; and
melting the collection of aluminum alloy scrap pieces with a vacuum smelting furnace.

7. The method as recited in claim 6, wherein the different aluminum alloy scrap pieces are selected from a group consisting of cast aluminum alloy scrap pieces, wrought aluminum alloy scrap pieces, and extrusion aluminum alloy scrap pieces.

8. The method as recited in claim 6, wherein the sorting is performed with an artificial intelligence neural network.

9. The method as recited in claim 8, wherein the artificial intelligence neural network is configured to sort the scrap pieces based on captured visual images of the pieces.

10. The method as recited in claim 6, wherein the collection of aluminum alloy scrap pieces contains less than 0.1% wt. magnesium.
